(19) United States
(12) Patent Application Publication
(10) Pub. No.: US 2012/0002560 A1
(43) Pub. Date: Jan. 5, 2012

(54) APPARATUS AND METHOD FOR SELECTING AP IN CONSIDERATION OF NETWORK PERFORMANCE

(75) Inventors: Jongtae SONG, Daejeon (KR); Soon Seok LEE, Daejeon (KR); Heuk PARK, Daejeon (KR); Sunghyun YOON, Daejeon (KR)

(73) Assignee: Electronics and Telecommunications Research Institute, Daejeon (KR)

(21) Appl. No.: 13/010,390

(22) Filed: Jan. 20, 2011

(30) Foreign Application Priority Data
Jun. 30, 2010 (KR) 10-2010-0062790

(51) Int. Cl. H04L 12/26

(52) U.S. Cl. 370/252

(57) ABSTRACT

Performance values between an access point (AP) and one or more networks to which the AP is connected are measured, and performance information is generated based on the measured performance values. When a request for the performance information is received from a terminal connected to the AP, the performance information is broadcast to the terminal at a pre-set time to allow the terminal to select an optimum AP based on the received performance information and attempt to access a wireless network.

### CROSS-REFERENCE TO RELATED APPLICATION

This application claims priority to and the benefit of Korean Patent Application No. 10-2010-0062790 filed in the Korean Intellectual Property Office on Jun. 30, 2010, the entire contents of which are incorporated herein by reference.

### BACKGROUND OF THE INVENTION

(a) Field of the Invention

The present invention relates to an apparatus and method for selecting a wireless network access point (AP) in consideration of network performance in an environment including a plurality of wireless local area network (WLAN) APs.

(b) Description of the Related Art

Currently, a WiFi (wireless fidelity) WLAN access employs a scheme in which a terminal compares the strengths of radio section signals of neighboring APs, selects an AP whose signal is received the best, and connects to a network. Alternatively, a method of providing information about signal strength to a user and selecting an AP desired by the user is employed.

When an AP is selected by using the signal strength of a radio section, even if the signal of the radio section is good, excessive traffic is generated in a wireline section to which the AP is connected, degrading quality of signals.

In case of the wireline section, Internet traffic is integrated in a metropolitan section and then transferred to an Internet edge, and in case of an Internet core network, packets are exchanged through a premium network or a best-effort network according to an Internet service for which a provider and an AP are connected. Accordingly, quality of service (QoS) perceived by users may vary depending on which metropolitan section, core network traffic, or packets is/are passing through.

Thus, a technique that may inform a user about the quality of a network to which APs are connected, rather than about a signal strength of a radio section, to allow the user to select an optimum AP is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus and method for selecting a wireless network access point having advantages of informing a user about the performance of a wireline network to which access points are connected, to thus allow the user to select an optimum access point, in an environment in which a plurality of wireless local area network (WLAN) access points can be used.

An exemplary embodiment of the present invention provides a method for selecting an access point (AP) that is connected to at least one network server and provides a network connection to the network server, to a terminal, including:

measuring at least one performance value between the AP and the at least one network server to which the AP is connected; generating performance information based on the measured performance value; receiving a request for the performance information from a terminal connected to the AP; and transferring the generated performance information to the terminal to allow the terminal to select an AP.

Another embodiment of the present invention provides a method for selecting an access point (AP) that is connected to at least one network server and provides a network connection to the network server, to a terminal, including:

measuring at least one performance value between the AP and the at least one network server to which the AP is connected; generating performance information based on the measured performance value and storing the same; receiving performance information from each of APs adjacent to the AP and storing the received performance information along with the generated performance information; and broadcasting the stored performance information to terminals located within the area of the AP.

Yet another embodiment of the present invention provides a method for selecting an AP providing a connection to a network to which at least one network server is connected, by a terminal, including:

requesting, by the terminal, performance information between the AP to which the terminal is connected and the network server, from the AP; receiving performance information with at least one network server to which the AP is connected, from the AP; determining an AP to be accessed based on the received performance information; and attempting a connection to the determined AP.

Still another embodiment of the present invention provides an apparatus for selecting an AP that is connected with at least one network server and provides a network connection to the network server, to a terminal, including:

a performance measurement unit configured to measure at least one performance value between the AP and at least one network server to which the AP is connected, and generate performance information based on the performance value; a performance information storage unit configured to receive the performance information that has been generated by the performance measurement unit and performance information that has been generated by APs adjacent to the AP, and store the same; and a performance information providing unit configured to transfer the performance information stored in the performance information storage unit to a terminal that requests the performance information, or to broadcast the performance information to one or more terminals within the area of the AP.

### BRIEF DESCRIPTION OF THE DRAWINGS

FIG. 1 illustrates a wireless network environment according to an exemplary embodiment of the present invention.

FIG. 2 is a schematic block diagram of an access point (AP) according to an exemplary embodiment of the present invention.

FIG. 3 is a schematic block diagram of a terminal according to an exemplary embodiment of the present invention.

FIG. 4 is a flowchart illustrating the process of a method for accessing an access point according to a first exemplary embodiment of the present invention.

FIG. 5 is a flowchart illustrating the process of a method for accessing an access point according to a second exemplary embodiment of the present invention.

FIG. 6 illustrates a MAC management frame according to an exemplary embodiment of the present invention.

FIG. 7 illustrates an information element according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

An apparatus and method for selecting a wireless network access point according to an exemplary embodiment of the present invention will now be described with reference to the accompanying drawings.

In an exemplary embodiment of the present invention, a wireless local area network (WLAN) is described as a reference for the sake of explanation, but the same technique can be applied to various wireless access techniques (e.g., WiMAX (worldwide interoperability for microwave access), HSDPA (high speed downlink packet access), Bluetooth, etc.). Also, like a terminal having multiple interfaces can simultaneously access WiFi and WiBro (wireless broadband) networks, an exemplary embodiment of the present invention can be applicable to heterogeneous wireless accessing techniques and also to a wireless accessing technique between heterogeneous providers.

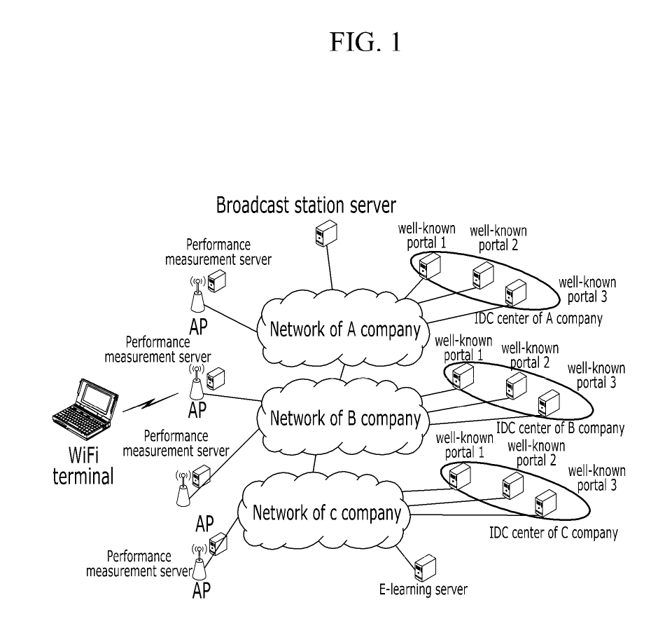

FIG. 1 illustrates a wireless network environment according to an exemplary embodiment of the present invention.

As shown in FIG. 1, a terminal is connected to various networks through access points (APs) installed in a house or a place of business to use the Internet. Methods for connecting the APs and the networks vary depending on network architectures of network providers providing wireline Internet services. In general, network providers configure an access network, a metropolitan network, and a core network according to sections. The networks of the respective sections are configured according to different methods.

Services allowing users to access and use the Internet through the terminal are dominated by Internet portals, contents services, or the like. Servers (referred to as “network servers” hereinafter) providing these services are managed by central data centers operated by the respective network providers or directly managed by respective companies. Quality actually perceived by users is largely dependent upon how smoothly APs and servers are connected in a wireline section, as well as upon signal strength in a radio section.

That is, even if the strength of a radio signal is good, if traffic from a server providing a service is congested because many users use the service, it would be better for the users to use a network having good performance even if the network provides lesser signal strength. To enable this, the terminal necessarily must check the performance of a network to which a corresponding AP is connected, before the terminal accesses a WLAN.

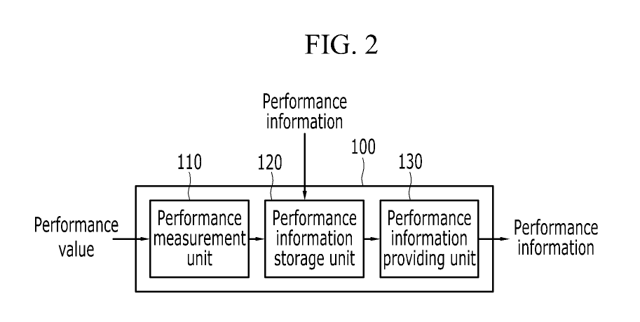

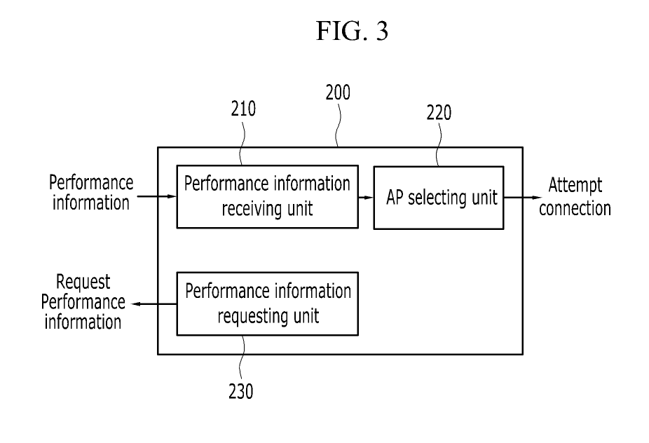

Thus, in an exemplary embodiment of the present invention, the AP provides situation information of a network to the terminal to allow the user to select an AP having good performance. The structures of the terminal and the AP according to an exemplary embodiment of the present invention will now be described with reference to FIGS. 2 and 3.

FIG. 2 is a schematic block diagram of an access point (AP) 100 according to an exemplary embodiment of the present invention, and FIG. 3 is a schematic block diagram of a terminal 200 according to an exemplary embodiment of the present invention.

As shown in FIG. 2, the AP 100 includes a performance measurement unit 110, a performance information storage unit 120, and a performance information providing unit 130, and as shown in FIG. 3, the terminal includes a performance information receiving unit 210, an AP selecting unit 220, and a performance information requesting unit 230.

The AP 100 according to an exemplary embodiment of the present invention includes a function as a performance measurement server for measuring performance with the server 300 of the network connected by a wireline with the AP, along with a basic function of the AP.

When the terminal 200 requests performance information, the performance measurement unit 110 of the AP 100 measures a performance value between the AP 100 and the network server 300 through communication with the servers 300 providing an Internet service, according to a pre-set period. In an exemplary embodiment of the present invention, extraction of the performance information of the network by measuring a round trip delay or the like is described as an example, but the present invention is not meant to be limited thereto. The method for measuring the performance value will be described later in detail.

The performance information storage unit 120 stores the performance information generated based on the performance value measured by the performance measurement unit 110. In this case, as for the performance information, only the performance information of the network to which the AP is connected may be stored, or performance information between the respective APs and the network servers 300 may be received from the other APs and stored at a time. In this case, the method for receiving information from the APs connected to neighboring networks has been known, so detailed information thereof will be omitted.

The performance information providing unit 130 provides the performance information stored in the performance information storage unit 120 to terminals. In this case, the performance information collected by the AP 200 to which the corresponding terminal 100 is connected may be transferred only to the terminal that has requested the performance information, or all performance information received from the neighboring APs may be broadcast to all the terminals located within the area of the AP 200, according to a performance measurement information requesting method. Also, when list information regarding services mainly used by the user is received from the performance information requesting unit 230 of the terminal 200, performance information with a network server providing the corresponding services may be transmitted.

The performance information receiving unit 210 of the terminal 200 receives the performance information that is provided or periodically broadcast by the performance information providing unit 130. The AP selecting unit 220 attempts accessing an AP selected by the user in order to attempt re-accessing an AP having the best performance as necessary based on the performance information.

The performance information requesting unit 230 requests performance information indicating a performance value between the AP 100 and the network server from the AP 100 to which the terminal 200 is initially connected. In this case, the performance information requesting unit 230 may make the request by including the information of the list of services mainly used by the terminal 200 that stores them in advance. The process of generating the information of the list of services and information formatting are known, so a detailed description thereof will be omitted.

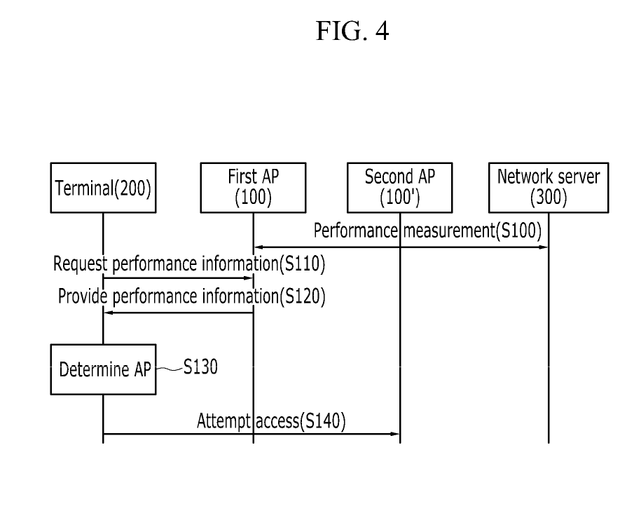

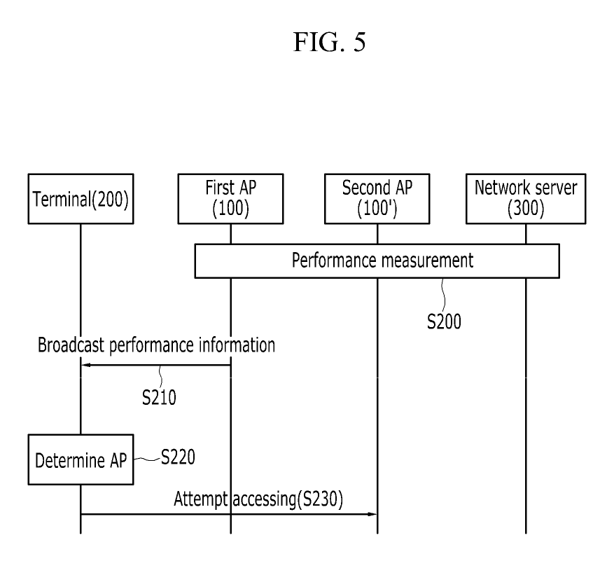

Next, a method for accessing an AP or a new AP in an environment having the structure of the terminal 200 and the AP 100 will now be described with reference to FIGS. 4 and 5.

FIG. 4 is a flowchart illustrating the process of a method for accessing an access point according to a first exemplary embodiment of the present invention, and FIG. 5 is a flowchart illustrating the process of a method for accessing an access point according to a second exemplary embodiment of the present invention.

FIG. 4 illustrates a method for accessing an AP according to a scheme in which performance information is acquired in a request manner, and FIG. 5 illustrates a method for accessing an AP according to a scheme in which performance information is acquired in a broadcast manner.

Before describing FIG. 4, a case in which the terminal 200 is connected with the first AP 100 and attempts to access a second AP 100′ based on performance information will be described as an example. As shown in FIG. 4, the performance measurement unit 110 of the first AP 100 measures connection performance with a plurality of network servers 300 (e.g., a major network site, an IDC center of a network provider, and the like) connected with the first AP 100 at every pre-set period (S100).

A performance value measured by the performance measurement unit 110 is determined based on one or more basic values such as round trip delay, loss, jitter, and the like, between the first AP 100 and the network servers 300. These values are collected through an Internet control message protocol (ICMP) ping command.

In this respect, in most cases, some of the network servers maintain a high level of security such that a ping function is disabled in preparation for a distribute denial of service (DDoS) attack, and the like. Thus, in order for the AP to measure the performance between the network servers employing such a high level of security and the AP, previous permission between the AP and the servers is prerequisite, and a detailed description thereof will be omitted.

The performance measurement unit 110 periodically measures a performance value between the first AP 100 and the network server 300, generates performance information based on the measured performance value according to a pre-set reference, and stores the generated performance information in the performance information storage unit 120. The performance information is stored in the performance information storage unit 120 in the form of a high level, a middle level, a low level, and the like, so that the user can easily understand them, but the present invention is not necessarily limited thereto.

When the terminal 200 initially accesses the first AP 100 and is allocated an IP address from the first AP 100 or from the network server 300, the terminal 200 requests performance information between the first AP 100 and all the network servers 300 to which the first AP 100 is connected by a wireline (S110). Then, the performance information providing unit 130 provides the performance information stored in the performance information storage unit 120 to the terminal 200 (S120). In this case, when the terminal 200 requests the performance information from the AP 100, the terminal 200 may also request information of a stored list of services from the performance information requesting unit 230.

Steps S110 and S120 may be performed in the process of selecting an optimum AP during an initialization process of the terminal 200 after the address of the first AP 100 is found, according to a dynamic host configuration protocol (DHCP). Alternatively, steps S110 and S120 may be performed through a separate application in the AP after the initialization process of the terminal 200 is finished.

The performance information receiving unit 210 of the terminal 200 delivers the performance information that has been received from the performance information providing unit 130 to the AP selecting unit 220, and upon receiving the performance information, the AP selecting unit 220 determines the second AP 100′ based on the received performance information (S130). The terminal 200 then attempts to access the determined second AP 100′ (S140).

Meanwhile, a method for acquiring performance information in a broadcast manner and selecting an AP according to a second exemplary embodiment of the present invention is illustrated in FIG. 5. The performance measurement unit 110 of the first AP 100 measures connection performance with the plurality of network severs 300 to which the first AP 100 is connected at every pre-set period in order to determine a performance value (S200).

The performance measurement unit 110 generates performance information based on the performance value measured in step S200, and stores the generated performance information in the performance information storage unit 120. Also, the performance measurement unit 110 receives performance information generated through calculation by APs including the second AP 100′ connected to a neighboring network, from the respective APs, and stores the received performance information in the performance information storage unit 120. The performance information providing unit 130 broadcasts all the performance information stored in the performance information storage unit 120 to every terminal located in the area of the AP at a pre-set time or at pre-set time intervals (S210).

The performance information receiving unit 210 of each terminal 200′receives the performance information that has been broadcast from the performance information providing unit 130. In this case, each terminal 200′ is not connected to the AP yet, and the AP selecting unit 220 determines the second AP 100′, an optimum AP, based on the performance information broadcast from the performance information providing unit 130 (S220).

Then, the terminal 200′ attempts to access the second AP 100′ that has been selected by the terminal 200′ (S230). The accessing performed in step S230 is an initial access of the terminal 200′.

The AP 100 according to the present exemplary embodiment is described as an example of an AP implemented in a form obtained by combining a performance measurement server for measuring performance between an AP and a network server and an AP performing the general function of an AP. However, these functions can be separated, without being necessarily integrated.

That is, when a general AP, not in such a form of being combined with a performance measurement server, is in use, a network communication provider may periodically measure round trip time (RTT) information according to the location of the AP and include it a database. Further, the terminal may be allowed to search performance information that has been included in a database in an application based on its location information, thereby allowing the terminal to access an optimum AP.

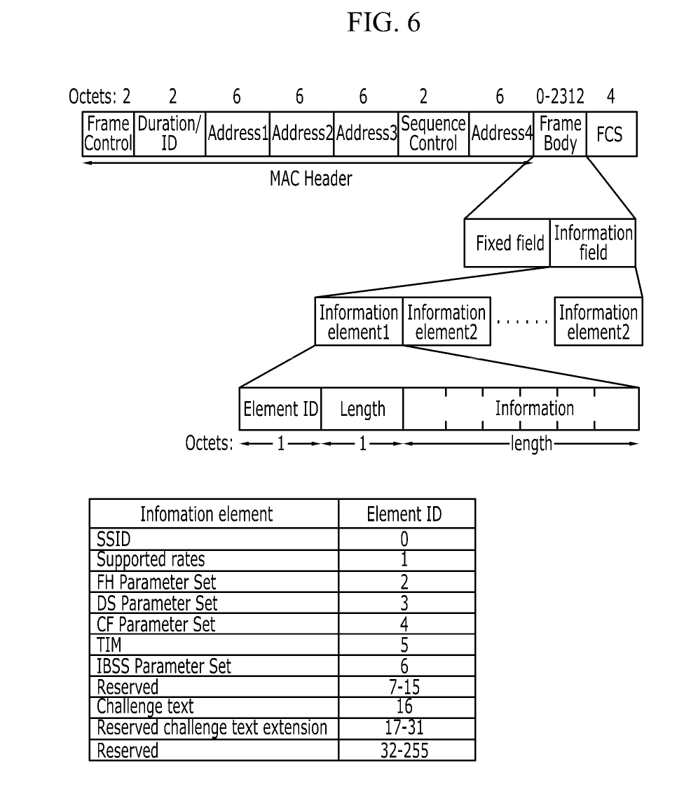

In this case, the performance information between the AP and a network may be delivered to the terminal in various manners. In particular, the most effective method is using a management frame of a media access control (MAC) that is used when a service set identifier (SSID) is broadcast. This will now be described with reference to FIG. 6.

FIG. 6 illustrates a MAC management frame according to an exemplary embodiment of the present invention.

As shown in FIG. 6, the MAC management frame provides various network information to a terminal by using an information field. Each information element is configured in the form of a type, length, and value (TLV), and is given an element ID according to respective information content.

For example, the SSID uses 0 as an element ID, and supported rates uses 1 as an element ID. Element ID 7˜15 and 32˜255 are currently not in use. Thus, one of the reserved IDs may be used to provide information, i.e., network status information, to the terminal.

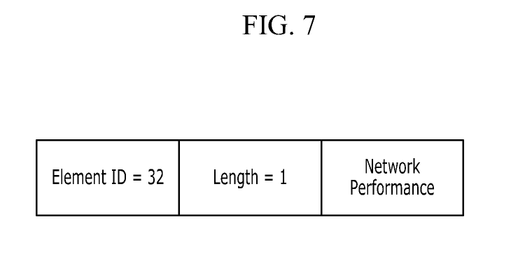

Next, a format configuration of performance information broadcast to terminals in FIG. 5 will now be described with reference to FIG. 7.

FIG. 7 illustrates an information element according to an exemplary embodiment of the present invention.

As shown in FIG. 7, in an exemplary embodiment of the present invention, the case in which the element ID 32 is used in the format of broadcast network performance information will be described as an example, but the present invention is not limited thereto.

Values of 0 to 255 can be used as the network performance values, and some of them may be represented as a network quality value. Also, a case using a decreasing scheme in which the better the network performance is, the smaller its value is will be described as a example.

Other values may be used for a special purpose (e.g., for a military purpose) or for a management purpose. For example, values of 0 to 127 may be used to represent performance values, and values of 128 to 255 may be used for a special purpose.

Meanwhile, information according to a request method provides performance information to the terminal 200 on the application of the AP 100, so the information elements of FIG. 7 can be variably implemented. That is, when an IP address is assigned, the address of the AP 100 including the function of a performance server may be informed to the terminal 200, so that the user can select an AP that is smoothly connected with a point largely used by the user.

To this end, when the terminal 200 requests performance information in FIG. 5, it may provide a list of services mainly used by the user to the AP 100, in order to receive performance information with each site or a representative site providing services. Then, upon receiving the service list, the AP can provide performance information of the nearest AP by using location information of the terminal having a function such as a GPS.

According to exemplary embodiments of the present invention, because a user can compare the performance of networks and access a wireless access point having the best performance, he can be provided with a high quality service.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for selecting an access point (AP) that is connected to at least one network server and provides a network connection to the network server, to a wireless terminal, the method comprising:
measuring at least one performance value between the AP and the at least one network server to which the AP is connected;
generating performance information based on the measured performance value;
receiving a request for the performance information from a terminal connected to the AP; and
transferring the generated performance information to the terminal to allow the terminal to select an AP.

2. A method for selecting an access point (AP) that is connected to at least one network server and provides a network connection to the network server, to a wireless terminal, the method comprising:
measuring at least one performance value between the AP and the at least one network server to which the AP is connected;
generating performance information based on the measured performance value and storing the same;
receiving performance information from each of APs adjacent to the AP and storing the received performance information along with the generated performance information; and
broadcasting the stored performance information to terminals located within the area of the AP.

3. The method of claim 1, wherein, in measuring the performance value, the performance value is measured from at least one of round trip delay, loss, and jitter between the AP and the network server.

4. The method of claim 2, wherein, in measuring the performance value, the performance value is measured from at least one of round trip delay, loss, and jitter between the AP and the network server.

5. The method of claim 3, wherein the performance value indicates performance of a wireline section between the AP and the at least one network server.

6. The method of claim 4, wherein the performance value indicates performance of a wireline section between the AP and the least one network server.

7. A method for selecting an access point (AP) providing a connection to a network to which at least one network server is connected, by a terminal, the method comprising:
requesting, by the terminal, performance information between the AP to which the terminal is connected and the network server, from the AP;
receiving performance information with at least one network server to which the AP is connected, from the AP;
determining an AP to be accessed based on the received performance information; and
attempting a connection to the determined AP.

8. The method of claim 7, wherein, in requesting the performance information, the performance information is requested by including information of a list of services used by the terminal.

9. The method of claim 7, further comprising
receiving performance information broadcast from the AP before the performance information is received.

10. An apparatus for selecting an access point (AP) that is connected with at least one network server and provides a network connection to the network server, to a terminal, the apparatus comprising:
a performance measurement unit configured to measure at least one performance value between the AP and at least one network server to which the AP is connected, and to generate performance information based on the performance value;
a performance information storage unit configured to receive the performance information that has been generated by the performance measurement unit and performance information that has been generated by APs adjacent to the AP, and store the same; and
a performance information providing unit configured to transfer the performance information stored in the performance information storage unit to a terminal that requests the performance information, or to broadcast the performance information to at least one terminal within the area of the AP.

11. The apparatus of claim 10, wherein the performance measurement unit measures the performance value from at least one among round trip delay, loss, and jitter between the AP and the network server.

12. The apparatus of claim 10, wherein the terminal comprises:
a performance information receiving unit configured to receive performance information transferred or broadcast from the performance information providing unit; and
an AP selecting unit configured to select an AP to be connected based on the performance information.

13. The apparatus of claim 12, wherein the terminal further comprises
a performance information requesting unit configured to request performance information from the AP to which the terminal is connected.

14. The apparatus of claim 13, wherein the performance information requesting unit provides information of a list of services used by the terminal to the AP.

15. The apparatus of claim 10, wherein the performance value indicates the performance of a wireline section between the AP and the at least one network server.
